(19) United States
(12) Patent Application Publication
(10) Pub. No.: US 2004/0238099 A1
(43) Pub. Date: Dec. 2, 2004

(54) Economical method of manufacturing features in a ceramic circuit board

(76) Inventors: Vincent J. Milano, Middleton, MA (US); Greg Mitchell, Windham, NH (US)

Correspondence Address: BOND, SCHOENECK & KING, PLLC, ONE LINCOLN CENTER, SYRACUSE, NY, 13202-1355, US

(21) Appl. No.: 10/447,700

(22) Filed: May 29, 2003

(51) Int. Cl. C03B 29/00

(52) U.S. Cl. 156/89.11; 156/89.12

(57) ABSTRACT

This invention is a method of forming features, such as counter-bore holes in a circuit board assembly. A first and second substrate are processed and counter-bore holes are formed in the first substrate. After the holes are formed, sealing glass is deposited on the bottom side of the first substrate and the top side of the second substrate and is sintered on the bottom side of the first substrate and the top side of the second substrate. After sintering, the bottom side of the first substrate is fixtured to the top side of the second substrate and the first and second substrate are refired, causing the sealing glass to reflow and fuse the bottom side of the first substrate to the top side of the second substrate. Finally, the first and second substrate are cooled.

### FIELD OF THE INVENTION

This present invention relates to electronic circuit devices and, more particularly, to a method of manufacturing circuit board assemblies that is used, for example, in high volume optical control circuits.

### BACKGROUND OF THE INVENTION

Circuit boards for electronic devices generally require features such as conductor patterns, through-holes, counter-bore holes, (that is, through-holes with a floor bottom at one end of the through hole) and via-holes formed in the substrates. The features in these circuit boards should be highly precise to facilitate the operation of high frequency electronic devices that are highly integrated and respond to high speed signals.

Demands for large scale integration and multiple function circuits have resulted in circuit boards having circuits not only on the front surface of the substrate but also on the rear surface. Electrical connections and control of devices between the front and rear surface of the substrate requires that the floor bottoms of counter-bore holes meet exacting tolerances. In circuit boards that require control of devices between the front and rear surfaces of ceramic board, the counter-bore holes must be formed with exacting precision.

The manufacturing techniques must fabricate features within the tolerance required by the design. Traditionally, precision counter-bore holes are formed in ceramic substrate using a single piece of ceramic substrate that is thicker than the required thickness of the finished product. Traditional ceramic fabrication techniques such as grinding or ultrasonic machine are used to form a counter-bore hole in one surface of the substrate. Subsequently, the opposite surface of the substrate is lapped and polished until the floor of the counter-bore hole is of the required thickness. This method requires multiple precision machining steps and uses traditional ceramic fabrication techniques of grinding or ultrasonic machines. It is not cost effective.

Another method used to manufacture counter-bore holes consists of forming a ceramic body having opposing and substantially planar first and second surfaces with through-holes passing entirely through the body. The step of forming includes the steps of molding an alumina slurry into a desired shape and punching the desired number of through-holes in the body. Once the through-hole has been formed, the ceramic body is coupled with other conductor substrates. Next the conductors are coupled by filling the through-holes with a copper paste, screen printing traces on the ceramic body, laminating additional ceramic layers and laminating the conductors. This method further includes co-firing the body and the conductors and metalizing the conductors as desired. Finally, the step of grinding forms the ceramic body to the prescribed dimensions. This method utilizes traditional ceramic fabrication techniques of grinding or ultrasonic machining both of the through-holes and of the ceramic body and is not cost effective.

In another method, a ceramic substrate is used as a support for interconnecting vias using copper. An inorganic material, comprising glass as a major component, is supplied in the form of a substrate that is manufactured by the green-sheet method. A slurry is made comprising a powdered inorganic material using organic binder and a solvent wherein the slurry is formed into a sheet. Vias (through-holes) are formed in the sheet by embedding an interconnection paste in the vias. Next, interconnections or patterns are formed on the sheet with interconnection paste. Two or more sheets are formed and then laminated together under pressure and heat treated. Counter-bore holes are similarly formed.

This method allows the organic binder in the laminate and the organic substance in the interconnection paste to decompose and they are thus eliminated. However, if the organic binder remains in the sintered compact, it will be converted to graphite and the quality of the substrate and conductive through-holes will deteriorate. For this reason, sufficient binder removal time must be allowed after the sintering step followed by another sintering period. This increases manufacturing costs. Furthermore, the difference in the sintering start time of the conductor and ceramic substrate causes serious problems in the substrate. Consequently sintering time and temperature are adjusted, which also increase manufacturing costs.

To alleviate the problems associated with the prior art, what is needed is a method of manufacturing features in ceramic substrate in a process that eliminates the need for conventional grinding and ultrasonic machining of the features, thereby saving time and reducing cost.

### SUMMARY OF THE INVENTION

It is an aspect of this invention to provide a method of manufacturing features such as counter-bore holes in a ceramic substrate that is cost effective.

It is another aspect of this invention to provide a method of manufacturing features such as counter-bore holes in a ceramic substrate that eliminates the need for conventional grinding and/or ultrasonic machining of the hole.

These and other aspects of this invention are apparent in a method of manufacturing a circuit board assembly including processing a first and second substrate, drilling through-holes in the first and the second substrate and then drilling counter-bore holes in the first substrate. Next, low temperature sealing glass is deposited on the bottom side of the first substrate and the top side of the second substrate. The sealing glass is sintered on the bottom side of the first substrate and the top side of the second substrate whereafter the bottom side of the first substrate is fixtured to the top side of the second substrate. The first and second substrate are then refired, reflowing the sealing glass to fuse the bottom side of the first substrate to the top side of the second substrate. Finally, the first and second substrate are cooled.

In another embodiment of this invention a circuit board assembly is manufactured by processing a first and second substrate, drilling through-holes in the first and second substrate and then drilling counter-bore holes in the first substrate. Next the bottom side of the first substrate and the top side of the second substrate are lapped to expose sealing glass embedded in the structure of the substrates, whereafter the bottom side of the first substrate is fixtured to the top side of the second substrate. The first and second substrate are then retired at high temperature, reflowing the sealing glass to fuse the bottom side of the first substrate to the top side of the second substrate. Finally, the first and second substrate are cooled.

### BRIEF DESCRIPTION OF THE DRAWINGS

FIG. 1 is a cross section showing a counter-bore hole and through-hole in the preferred embodiment of the invention.

FIG. 2 is an enlarged cross section view of a counter-bore hole in the preferred embodiment of the invention.

FIG. 3 is a top view of the counter-bore holes and through-holes in the preferred embodiment of the invention.

### DETAILED DESCRIPTION OF THE INVENTION

While the present invention is described below with reference to circuit board assemblies, a practitioner in the art will recognize the principles of the present invention are applicable elsewhere.

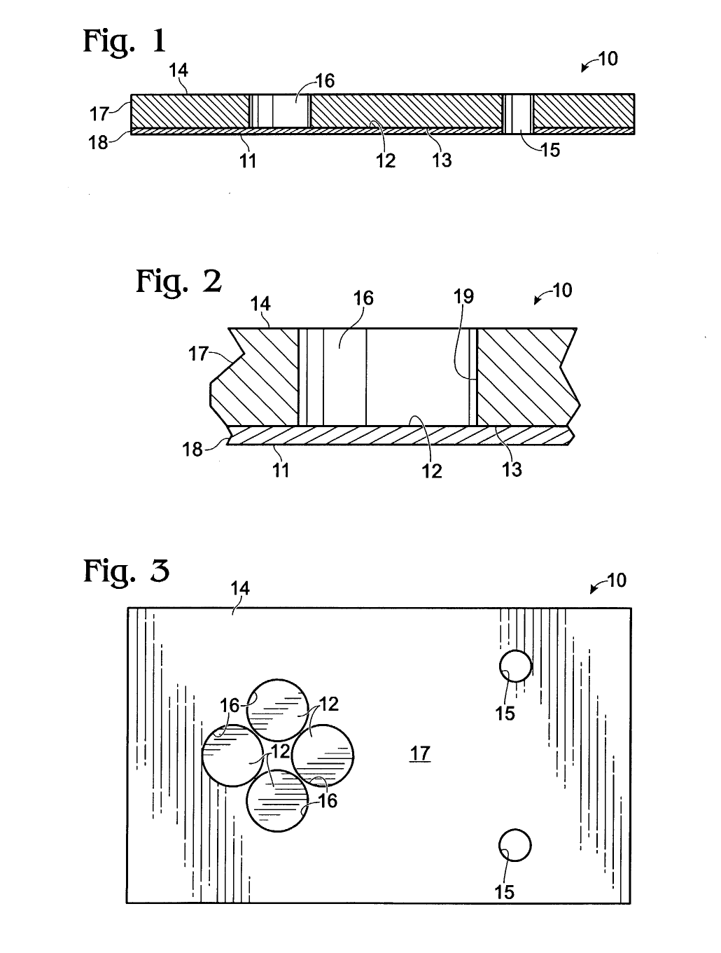

As shown in FIGS. 1 through 3, the method of the invention comprises processing the first substrate 17 and processing the second substrate 18. The through-holes 15 are formed in the first substrate 17 and the second substrate 18. The through-holes are formed in the first substrate and second substrate before they are fused together. The counter-bore holes 16 are formed only into the first substrate 17. This is also accomplished prior to the first and second substrate being fused.

The ceramic substrates are usually cut from a ceramic sheet by grinding using a rotary wheel. However, when a thin layer, for example, a high polymer material, is present in a cutting region of a ceramic substrate it leads to undesirable clogging of the gaps between the grains of the grinding wheel. This occurrence obstructs the cutting operation and leads to the shortened useful life of the grinding wheel. However, as is the practice in the art, this trouble is avoided by removing beforehand the thin layer of the high polymer material from the cutting region by dry etching.

The processing of the first and second substrate varies with application. It is possible to provide a sintered ceramic substrate body with various materials such as alumina (Al₂O₃), beryllia, aluminum nitride (AlN), magnesia (MgO), glass ceramics and the like. The first substrate 17 and the second substrate 18 of assembly 10 are in various applications different material. If strength is a design criteria then the alumina substrate containing from 88 to 99.5% by weight of alumina is preferred. On the other hand if heat conductivity is a design criteria then AlN or beryllia is preferred. If heat and strength characteristics are desired the first substrate 17 and the second substrate 18 consist of different materials to reflect these characteristics. Furthermore, ceramic substrate bodies are provided with a preferred size or they are manufactured to specific design parameters.

When a multiple layer ceramic circuit board is manufactured, for example, a ceramic powder such as Alumina powder and Pb—Zn—B glass powder is mixed to provide a ceramic board with high strength. This mixed powder is then dispersed into solvent together with organic binder, such as acryl resin and the like, whereby the viscosity of the slurry is about 2500 cps. In this application the ceramic powder is in the range of 50%-70% by weight with the glass powder in the 30%-50% by weight range. The ceramic powder has an average granular diameter between 9-20 μm with the glass powder diameter about 3 μm. If the ceramic powder granular diameter is less than 9 μm a pore magnitude becomes smaller that decreases the dielectric constant. On the other hand if the granular diameter of the ceramic powder is more than 20 μm, a pore magnitude becomes greater that increases the dielectric constant. Furthermore, if the viscosity of the slurry is greater than 3000 cps, the slurry is too thick to pour and cast upon a green sheet 20 resulting in a defective shape and surface.

The processing of the first substrate 17 and the second substrate 18, depending on the application, includes a ceramic body with good heat transfer characteristics. For example, an aluminum nitride (AlN) sintered body has an average grain size of 2 μm or less, a thermal conductivity of 80 W/m-K° or more and a relative density of 98% or more. In addition, the strength of the AlN sintered body is high because of its relative density. Also its surface smoothness is very high. Therefore, the AlN sintered body is suitable particularly as an insulating layer of a circuit board, or the like, where a fine conductor layer is formed.

In the preferred embodiment of the invention the first substrate 17 is about 0.050 inches thick and the second substrate is about 0.010 inches thick for a combined assembly 10 thickness of about 0.060 inches thick. However, the thickness of the first substrate 17 and the second substrate 18 vary with the application of assembly 10. The counter-bore hole(s) 16 in the first substrate are formed all the way through. When the first substrate 17 is fixtured, that is, stacked, positioned and aligned, onto the second substrate 18, the counter-bore hole(s) 16 has the depth of the first substrate which is 0.050 inches in the preferred embodiment of the invention. Furthermore, the counter-bore hole(s) in the first substrate 17 when fixtured to the second substrate 18 has as its floor bottom the second substrate 18 which in the preferred embodiment of the invention is 0.010 inches thick. As is known in the art, the floor thickness, that is the thickness of the second substrate, varies from about 0.005 inches to 0.500 inches. Also the counter-bore hole(s) 16 depth varies depending on the thickness of the first substrate 17 and is in the range of about 0.010 inches to 1.010 inches.

Referring to FIG. 1, the circuit board assembly 10 consists of features, specifically, through-holes 15, that are formed in the first substrate 17 and the second substrate 18 by the use of conventional drilling, constant laser or pulsed laser before the substrates are joined together. Other features, such as counter-bore holes(s) 16, are typically pulsed laser drilled. However, different drilling techniques are substitutable for the pulsed laser technique depending on the application. For example, in one application the through-holes 15 are formed by constant laser or conventional drilling and the counter-bore hole(s) 16 are formed by pulsed laser drilling. The pulsed laser drilling is used to provide a wall 19 to a counter-bore hole 16 as shown in FIG. 2. However the straight wall 19 is substitutable for a tapered, convex or concave wall with different applications. As will be evident to those skilled in the art, the present invention can be used to form features of a variety of shapes, including square, round, rectangular, oval, irregular and others.

If needed, once the counter-bore hole 16 or through-hole 15 has been drilled, a laser post pulse lapping technique, as known by the practitioner in the art, is used for enhancing the counter-bore hole(s) 16. The laser drilling is accomplished with a laser source and optics system that directs a focused beam of energy onto the first substrate 17 or the second substrate 18. Either the first substrate or second substrate is positioned on an X-Y positioning table. Although, in the preferred embodiment of the invention, the through-holes 15 and counter-bore holes 16 formed are circular, a plurality of shapes are formed using the X-Y positioning table including, but not limited to, oval, square or the like. Furthermore, the counter-bore holes(s) and through-hole(s) vary in size depending on the design parameters of the ceramic circuit board.

Optimum values of wavelength and power of the laser are determined depending on, for example, the material and thickness of the first substrate 17 and the second substrate 18 and the holes to be drilled. A wavelength range varies about 150 nm to 400 nm and the power or energy density varies from about 0.5 J per centimeter squared to 5.0 J per centimeter squared. The pulse width of the laser is in the range of about 100 ps to 1 μs. Consequently, the wavelength and power requirement to drill the first substrate 17 is different from that for the second substrate 18. Furthermore, when the energy of the laser is excessively high, the ceramic substrate through-hole(s) and counter-bore hole(s) will be damaged and the surface properties of the substrates degraded.

After the first substrate 17 and second substrate 18 are processed and the desired holes have been formed in the first substrate 17 and second substrate 18, a thin amount of sealing glass powder is deposited on the bottom side 13 of the first substrate 17 and on the top side 12 of the second substrate 18. The amount of sealing glass powder varies depending on the design. In the preferred embodiment of the invention a thin film of sealing glass about 0.001-0.002 inches thick is deposited on the bottom side 13 of the first substrate 17 and top side 12 of the second substrate 18. The sealing glass in the preferred embodiment of the invention is silicon dioxide (SiO₂). The silicon dioxide (silica) is a low temperature softening glass with a softening point of about 600° C. to 850° C., a dielectric constant of less than 5.7 and a coefficient of thermal expansion that is slightly less than alumina. As is known by the practitioner in the art, the sealing glass used to fuse the first substrate 17 to the second substrate 18 needs to be a material where the coefficient of thermal expansion approximates that of the substrate material. Therefore, different materials are substitutable for silicon dioxide as long as there is a similarity in the coefficient of thermal expansion between the sealing glass chosen and the first and second substrate material. For example, other derivative sealing powders are SiO₂—PbO, SiO₂—ZnO, SiO₂—Bi₂O₃ and the like. If the thermal expansion of the substrates differs greatly from that of the sealing glass then the reliability of the connection bonding is greatly reduced. Furthermore, differences in thermal expansion coefficients create tensile stresses from the center of the through-holes(s) 15 that are exerted in the radial direction. The differences in thermal expansion coefficients create compressive stresses from the center of the through-hole(s) 15 that are exerted in the circumferential direction. Ceramic substrates are strong against compressive stresses but weak in tensile stresses. These stresses act to separate the boundaries between the through-hole(s) 15 and the ceramic first substrate 17 and the second substrate 18. Furthermore, a different first substrate 17 material is fusible with different second substrate 18 material as long as there is a good match with their respective coefficients of thermal expansion and the sealing glass.

The sealing glass powder is held in place on the bottom side 13 of the first substrate 17 and the top side 12 of the second substrate 18 by individually sintering the substrates with the top side 12 and bottom side 13 facing up. A thin layer of glass about 0.001-0.002 inches thick is deposited on their respective surfaces. The first substrate 17 and the second substrate 18 have initial sintering for about 30 minutes at about 850° C. to soften the glass powder allowing it to adhere to the substrate. The first and second substrates are then air cooled to ambient temperature. This initial sintering fills the pores of the top side 12 of the second substrate and bottom side 13 of the first substrate as the liquid formed as the glass powder rises above its melting point, bonding the sealing glass to the substrate as it cools.

When the first and second substrate are substantially cooled to ambient temperature they are fixtured to each other. Fixturing of the first substrate 17 and the second substrate 18 stacks, positions and aligns the substrates to one another. The first outer surface 11 and the second outer surface 14 of assembly 10 are checked to ensure that the first outer surface and second outer surface are planar, are not warped and are parallel to each other.

After fixturing, the assembly 10 comprising the first substrate 17 and the second substrate 18 is refired at about 1600° C. for about 5-6 hours as is known in the art. The refiring temperature depends on the material composition of the first and second substrate. The previously sintered sealing glass is reheated to a high temperature, reflowing the glass, fusing the top side 12 of the second substrate 18 to the bottom side 13 of the first substrate 17. The ceramic substrate assembly sufficiently densifies at about 1600° C. in the preferred embodiment of the invention. Furthermore, an appropriate sintering assistant is added, before the sintering step to the sealing glass, when the liquid phase of the fusing process is desired to be at a lower temperature than without the assistant. However, as is known by the practitioner in the art the actual refiring process depends on the material being refired. For example, if AlN is to be refired, the assembly 10 is heated in a nonoxidizing atmosphere such as the nitrogen in which it typically is sintered in the temperature range of about 1300° to 1550° C. Furthermore, it is desirable that this sintering be performed in a nitrogen gas atmosphere with assembly 10 contained in a vessel consisting of MN or graphite with the sintering time between about 10 minutes to many hours. Consequently it is possible to manufacture an AlN sintered assembly 10 with an average MN grain size of 2 μm or less, a high thermal conductivity of 80 W/m-K or more and improved strength resulting from fine MN grains.

In another embodiment of the present invention, the first substrate 17 and the second substrate 18 are processed and the desired holes have been formed in the first substrate 17 and the second substrate 18, the top side 12 of the second substrate 18 and the bottom side 13 of the first substrate 17 are lapped to expose sealing glass that is inherent in the structure of the ceramic substrate. The first substrate 17 and the second substrate 18 are then fixtured to each other. Fixturing of the first substrate 17 and the second substrate 18 stacks, positions and aligns the substrates to one another. The first outer surface 11 and the second outer surface 14 of assembly 10 are checked to ensure that the first outer surface and second outer surface are planar, are not warped and are parallel to each other. After fixturing, the assembly 10, comprising the first substrate 17 and the second substrate 18 is refired at about 1,600° C. for about 5-6 hours as is known in the art. The refiring temperature depends on the material composition of the first and second substrate. The exposed sealing glass on the bottom side 13 of the first substrate 17 and on the top side 12 of the second substrate 18 is reheated to a high temperature, reflowing the glass and fusing the top side 12 of the second substrate 18 to the bottom side 13 of the first substrate 17. After refiring, the assembly 10 is cooled.

FIG. 3 shows a top view of assembly 10. While this top view shows the preferred embodiment of the invention with four counter-bore holes 16 and two through-holes 15, a practitioner in the art understands that numerous counter-bore holes and through-holes are possible in assembly 10 depending on the application and that other features and shapes may be manufactured using the present invention. The counter-bore holes 16 are shown as round with the top side 12 of the second substrate 18 as the thin floor base at the bottom of each counter-bore hole 16. Furthermore the round counter-bore hole(s) 16 is substitutable for counter-bore hole(s) that are elongated, oblong, oval, rectangular, or irregular, depending on the application.

While there has been illustrated and described what is at present considered to be the preferred embodiment of the invention, it will be appreciated that numerous changes and modifications are likely to occur to those skilled in the art. It is intended in the appended claims to cover all those changes and modifications that fall within the spirit and scope of the present invention.

What is claimed is:

1. A method of manufacturing a circuit board assembly comprising:
a) processing a first substrate;
b) processing a second substrate;
c) forming at least one feature in the first substrate;
d) depositing a scaling glass on the bottom side of the first substrate and the top side of the second substrate;
e) sintering a sealing glass on the bottom side of the first substrate and the top side of the second substrate;
f) fixturing the bottom side of the first substrate and the top side of the second substrate;
g) refiring the first substrate and the second substrate for reflowing the sealing glass to fuse the bottom side of the first substrate to the top side of the second substrate; and
h) cooling the fused first substrate and second substrate.

2. The method of claim 1 wherein said at least one feature is circular in shape.

3. The method of claim 1 wherein said at least one feature rectangular in shape.

4. The method of claim 1 wherein said at least one feature irregular in shape.

5. The method of claim 1 wherein said at least one feature formed on an edge of the first and second substrates.

6. A method of manufacturing a circuit board assembly comprising:
a) processing a first substrate;
b) processing a second substrate;
c) forming at least one feature in the first substrate;
d) lapping the bottom side of the first substrate and the top side of the second substrate;
e) fixturing the bottom side of the first substrate and the top side of the second substrate;
f) refiring the first and second substrate to fuse the bottom side of the first substrate to the top side of the second substrate; and
g) cooling the fused first and second substrate.

7. The method of claim 1 wherein said at least one hole is circular in shape.

8. The method of claim 1 wherein said at least one hole is rectangular in shape.

9. The method of claim 1 wherein said at least one hole is irregular in shape.

10. The method of claim 1 wherein said at least one hole is formed on an edge of the first and second substrates.
